(19) United States
(12) Patent Application Publication
(10) Pub. No.: US 2025/0274873 A1
(43) Pub. Date: Aug. 28, 2025

(54) METHOD AND APPARATUS OF PERFORMING POWER CONTROL ON WIRELESS COMMUNICATION DEVICE WITH POWER ESTIMATION CALIBRATION AND RELATED WIRELESS COMMUNICATION DEVICE

(71) Applicant: MEDIATEK INC., Hsin-Chu (TW)

(72) Inventors: Chih-Chieh Lai, Hsinchu City (TW); Chung-Pi Lee, Hsinchu City (TW); Yabo Li, San Jose, CA (US); Wei-Jen Chen, Hsinchu City (TW); Jianwei Zhang, Beijing (CN); Ming-Chun Chiang, Hsinchu City (TW)

(73) Assignee: MEDIATEK INC., Hsin-Chu (TW)

(21) Appl. No.: 18/585,063

(22) Filed: Feb. 23, 2024

(51) Int. Cl. H04W 52/24

(52) U.S. Cl. CPC H04W 52/245

(57) ABSTRACT

An apparatus for perform power control on a wireless communication device includes: a power estimator, a power meter, a calibration unit and a control unit. The power estimator is configured to generate an estimated power value by querying power mapping information according to scenario information. The power meter is configured to generate a measured power value based on measurement of power supplied to partial circuits of the wireless communication device. The calibration unit is coupled to the power estimator and the power meter and configured to generate a calibrated power value according to the estimated power and the measured power, and accordingly to update the power mapping information based on the calibrated power value and the scenario information. The control unit is coupled to the power estimator and configured to perform power control on the partial circuits of the wireless communication device according to the estimated power value.

### BACKGROUND

The present invention relates to wireless communications, and more particularly to a method and an apparatus of performing power control on wireless communication device with power estimation calibration and related wireless communication device.

In wireless communications systems, user equipment (UE) plays a critical role as the endpoint of user communication. It is a device that allows end-users to access network services, ranging from voice calls to high-speed data transmission. Power control in UE is crucial for several reasons. Firstly, it helps in maintaining the quality of the signal transmitted and received, ensuring efficient communication. Secondly, power control is essential for conserving battery life of the UE, which is particularly important for mobile devices. Thirdly, it aids in minimizing interference with other devices, as excessive power in signal transmission can lead to interference in a network, disrupting communication for other users. The process of power control in UE involves power estimation, which is a sophisticated technique to determine an optimal power level for signal transmission. Power estimation takes into account various factors like distance from the base station, the required quality of service, and the current network conditions. The UE utilizes algorithms to estimate minimum power required to maintain a reliable connection without causing unnecessary interference. This estimation is continuously updated based on changing network conditions, user movement, and varying signal strengths. By adjusting its transmission power according to these estimations, the UE optimizes its performance in the network, ensuring efficient and reliable communication.

### SUMMARY

With this in mind, it is one object of the present invention to provide a precise power control mechanism for use in a wireless communication device, such as an user equipment. Embodiments of the present invention rely on power mapping information to perform scenario-aware power estimation of the wireless communication device based on a current scenario of the wireless communication device. Accordingly, the power control mechanism performs power control on the wireless communication device according to the power estimation result. To improve effectiveness of the power control mechanism of the present invention, a calibration process is utilized to update the power mapping information, allowing the power mapping information to be more preciously to reflect actual power consumption of the wireless communication device.

According to one embodiment, an apparatus for perform power control on a wireless communication device is provided. The apparatus comprises: a power estimator, a power meter, a calibration unit and a control unit. The power estimator is configured to generate an estimated power value by querying power mapping information according to scenario information. The power meter is configured to generate a measured power value based on measurement of power supplied to partial circuits of the wireless communication device. The calibration unit is coupled to the power estimator and the power meter and configured to generate a calibrated power value according to the estimated power and the measured power, and accordingly to update the power mapping information based on the calibrated power value and the scenario information. The control unit is coupled to the power estimator and configured to perform power control on the partial circuits of the wireless communication device according to the estimated power value.

According to one embodiment, a method of performing power control on a wireless communication device is provided. The method comprises: generating an estimated power value by querying power mapping information according to scenario information; generating a measured power value based on measurement of power supplied to partial circuits of the wireless communication device; generating a calibrated power value according to the estimated power value and the measured power value, and accordingly updating the power mapping information based on the calibrated power value and the scenario information; and performing power control on the partial circuits of the wireless communication device according to the estimated power value.

According to one embodiment, a wireless communication device is provided. The wireless communication device comprises: a power meter and a power control module. The power meter is configured to generate a measured power value based on measurement of power supplied to partial circuits of the wireless communication device. The power control module is configured to perform power control on the wireless communication device. The power control module comprises: a power estimator, a calibration unit and a control unit. The power estimator is configured to generate an estimated power value by querying power mapping information according to scenario information. The calibration unit is coupled to the power estimator and the power meter and configured to generate a calibrated power value according to the estimated power value and the measured power value, and accordingly to update the power mapping information based on the calibrated power value and the scenario information. The control unit is coupled to the power estimator and configured to perform power control on the partial circuits of the wireless communication device according to the estimated power value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram an apparatus of performing power control for use in a wireless communication device according to one embodiment of the present invention.

FIG. 2 illustrates a power look-up table according to one embodiment of the present invention.

FIG. 3 illustrates modifications on a power look-up table according to one embodiment of the present invention.

FIG. 4 illustrates a flow chart of a method of performing power control according to one embodiment of the present invention.

FIG. 5 illustrates an exemplary wireless communication network according to one embodiment of the present invention.

FIG. 6 is a schematic diagram illustrating an example of a hardware configuration of a wireless communication device according to one embodiment of the present invention.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The singular forms “a,” “an” and “the” include plural referents unless the context clearly dictates otherwise. Reference throughout this specification to “one embodiment” or “an embodiment” means that a particular feature, structure, or characteristic described in connection with the embodiment is included in at least one embodiment of the present disclosure. Therefore, the appearances of the phrases “in one embodiment” or “in an embodiment” in various places throughout this specification are not necessarily all referring to the same embodiment. Further, the particular features, structures, or characteristics may be combined in any suitable manner in one or more embodiments.

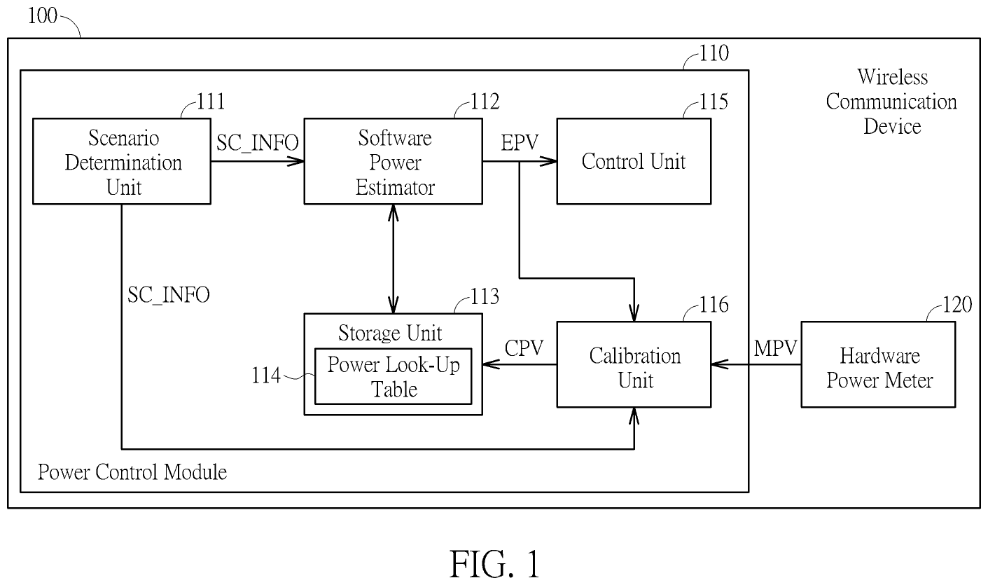

Please refer to FIG. 1, which illustrates an apparatus of performing power control for use in a wireless communication device according to one embodiment of the present invention. As illustrated, a wireless communication device 100 comprises a power control module 110 and a hardware power meter 120. The power control module 110 comprises a scenario determination unit 111, a software power estimator 112 and a storage unit 113, a control unit 115 and a calibration unit 116. Typically, the power control module 110 is configured to perform a power control on partial circuits of the wireless communication device 100 according to at least one estimated power value EPV generated by the software power estimator 112. In one embodiment, the power control module 110 is configured to perform power control on a modem circuit (not shown) of the wireless communication device 100.

The scenario determination unit 111 is configured to generate scenario information SC_INFO based on operational-related data collected from various components and/or circuits of the wireless communication device 100 to determine the scenario information SC_INFO. In one embodiment, the operational-related data collected from various components and/or circuits of the wireless communication device 100 may be associated with functions, operations, tasks, processes that are performed by components and/or circuits of the wireless communication device 100. The scenario information SC_INFO is indicative of a current scenario of the wireless communication device 100. In one embodiment, the current scenario may indicate the wireless communication device 100 is performing an uplink transmission with a base station and a corresponding transmission power required by the uplink transmission, or performing a downlink transmission with a base station. In one embodiment, the current scenario may indicate the wireless communication device 100 is monitoring a physical downlink control channel (PDCCH) between a base station for incoming control information. In one embodiment, the current scenario may indicate the wireless communication device 100 is entering a sleep mode (e.g., a deep sleep mode or an idle mode).

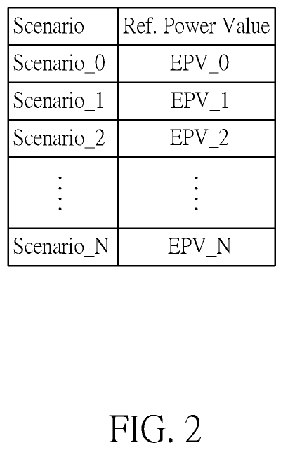

According to the determined scenario information SC_INFO, the software power estimator 112 quires power mapping information recorded in a power look-up table 114 stored in the storage unit 113. Please refer to FIG. 2 which illustrates an exemplary power look-up table according to one embodiment of the present invention. As illustrated, a power look-up table 114 uses scenarios of the wireless communication device 100 as index. Each entry of the power look-up table records one of possible scenarios (e.g., Scenario 0-Scenario N) of the partial circuits (e.g., a modem circuit) of the wireless communication device 100 and a corresponding reference power value (e.g., EPV_0-EPV_N). By querying the power look-up table 114, the software power estimator 112 could generate the estimated power value EPV according to the reference power value derived from the power look-up table 114, which is indicative of estimated power consumption of partial circuits of the wireless communication device 100 under a specific scenario indicated by the scenario information SC_INFO. Moreover, the power look-up table 114 may be stored permanently in a non-volatile memory (e.g., flash memory) of the wireless communication device 100 and loaded to a volatile memory (e.g., DRAM or SPAM) when power control process of the power control module 110 is initiated.

Besides, the power mapping information recorded in the power look-up table 114 can be collected through a factory test on a test device. Due to various factors, such as insufficient power mapping information (since the space of the storage unit 113 is limited), process variation (causing differences in the characteristics of components and/or circuits within the wireless communication device 100, thereby making the overall characteristics of the wireless communication device 100 different from those of the test device in the factory test), or due to variations in environmental temperature or power supply voltage, even under the same scenario, the power consumption of the wireless communication device 100 may vary and be difficult to ascertain. Consequently, the estimated power value EPV derived according to the power look-up table 114 may not precisely reflect the actual power consumption of partial circuits of the wireless communication device 100 under the current scenario. This inaccuracy in power estimation can adversely affect the effectiveness of the power control performed by the power control module 110. In view of this, the power control module 110 relies on the calibration unit 116 to update/modify the power mapping information recorded in the power look-up table 114 to improve the accuracy of power estimation.

Specifically, the hardware power meter 120 is configured to generate a measured power value MPV based on measurement of power supplied to partial circuits of the wireless communication device 100. In one embodiment, the hardware power meter 120 generates the measured power value MPV based on measurement of power supplied to a modem circuit of the wireless communication device 100. According to various embodiments, the hardware power meter 120 can be could be a data acquisition system (DAQ), a data recorder, or an oscilloscope and can obtain measurement of voltages and currents supplied by power sources (not shown) inside or outside the wireless communication device 100.

The calibration unit 116 would generate a calibrated power value CPV according to the estimated power value EPV and the measurement power value MPV according to one or more specific calibration algorithms. The one or more calibration algorithm can use machine-learning-based methods or other techniques to improve accuracy. In one embodiment, the one or more specific calibration algorithms could include machine-learning-based algorithms, such as a recursive least square (RLS) algorithm or a least mean square (LMS) algorithm. According to the calibrated power value CPV and a current scenario indicated by the scenario information SC_INFO, the calibration unit 116 is configured to modify corresponding one or more entries of the power look-up table 114. For example, if the current scenario indicated by the scenario information SC_INFO is associated with uplink transmission of the wireless communication device 100, the calibration unit 116 would modify corresponding one or more entries associated with uplink transmission.

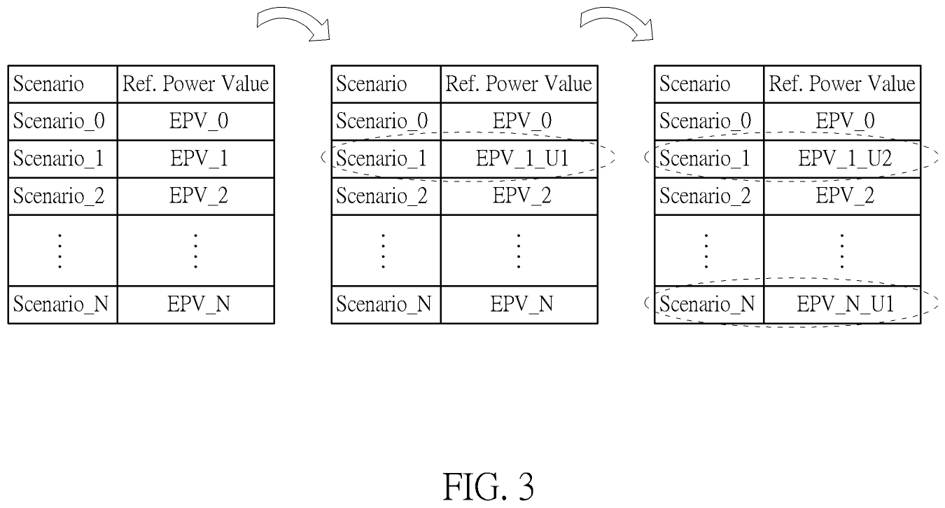

Please refer to FIG. 3 for further understandings. For example, if a current scenario indicated by the scenario information SC_INFO is Scenario_1, the calibration unit 116 could modify its corresponding reference power value from “EPV_1” to “EPV_1_U1” with the currently generated calibrated power value CPV. Moreover, as illustrated in the figure, any entry of power look-up table 114 could be modified (e.g., reference power value corresponding to Scenario N can also be modified) with the calibrated power value CPV and could be modified more than one times (e.g., reference power value corresponding to Scenario_1 can be modified from “EPV_1” to “EPV_1_U1” and then to “EPV_1_U2”).

Once the estimated power value EPV is obtained, the control unit 115 is configured to perform power control on partial circuits (e.g., a modem circuit) of the wireless communication device 100 according to the estimated power value EPV. According to various embodiments, the control unit 115 could send commands, instructions and/or signals to a variety of components, elements, circuits of the wireless communication device 100 in order to adjust power levels of these components, elements, circuits individually, thereby to achieve reasonable and precise power control.

The power control and calibration mentioned above could be periodically performed based on a specific control interval. For example, the scenario determination unit 111 could generate scenario information SC_INFO for each transmission time interval (TTI). The power meter 120 could generate the measured power value MPV for each TTI. Specifically, the power meter 120 could generate the measured power value MPV based on an average of samples of measurement of power supplied to the partial circuits of the wireless communication device 100 during one TTI. The calibration unit 116 could generate the calibrated power value CPV for each TTI. The control unit 115 could perform power control on the partial circuits of the wireless communication device 100 for each TTI. Please note that TTI is an example of a control interval rather than a limitation of the present invention.

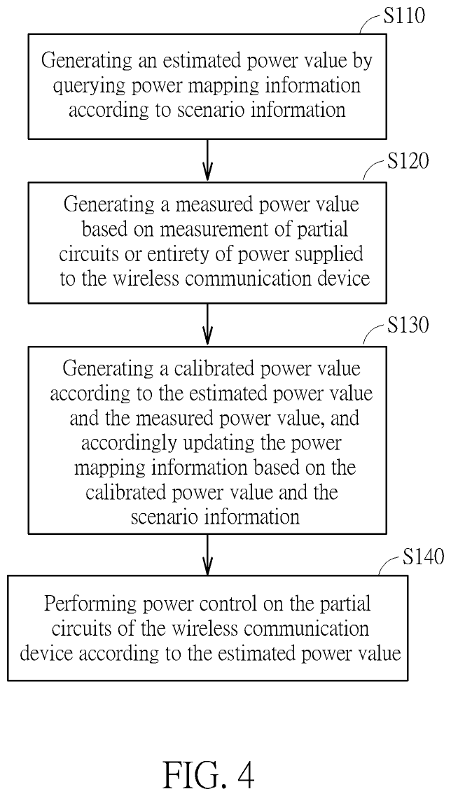

Based on the above descriptions, FIG. 4 illustrates a flow chart of a method of performing power control on a wireless communication device according to one embodiment of the present invention. As shown, the method includes the following steps:

Step S110: generating an estimated power value by querying power mapping information according to scenario information;

Step S120: generating a measured power value based on measurement of partial circuits of power supplied to the wireless communication device;

Step S130: generating a calibrated power value according to the estimated power value and the measured power value, and accordingly updating the power mapping information based on the calibrated power value and the scenario information; and

Step S140: performing power control on the partial circuits of the wireless communication device according to the estimated power value.

The principles and specific details of the above steps have been thoroughly explained through previous embodiments and are not reiterated here. It should be noted that the aforementioned flow can be enhanced by adding additional steps or through appropriate modifications and adjustments to better achieve the power control on the wireless communication device, thereby improve the power efficiency and performance of the wireless communication device.

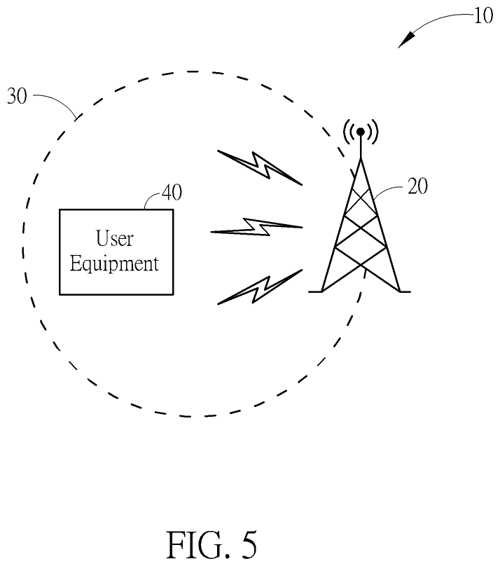

FIG. 5 illustrates an exemplary wireless communication network according to one embodiment of the present invention. As illustrated, a wireless communication network 10 comprises a base station 20, a cell 30, an user equipment 40 (which can be the wireless communication device 100). The wireless communication network 10 is configured to support communication between a number of users. Communication coverage in the cell 30 may be provided by the base station 20. The base station 20 may interact with a plurality of wireless communication devices, for example, the user equipment 40 (e.g., wireless communication device 100) and other wireless communication device (not shown). The user equipment 40 (e.g., the wireless communication device 100) may be a device (e.g., a mobile phone, a tablet, a personal computer, a laptop, a portable game console, etc.) used by a user to send and receive voice or data over a communications network. The user equipment 40 (e.g., the wireless communication device 100) may transmit information to and receive information from another wireless communication device in another cell (not shown). The user equipment 40 (e.g., the wireless communication device 100) may accomplish this by first communicating with the base station 20 via a wireless link. For example, the user equipment 40 (e.g., the wireless communication device 100) may generate and transmit a message to the base station 20. The base station 20 may then generate and transmit a message to another wireless communication device.

The block diagram shown by FIG. 1 used in the description of the above embodiment illustrates blocks of functional units. Some of these functional blocks (components) can be implemented by any combination of hardware and/or software. Moreover, the method of implementing functional blocks is not limited. That is, each functional block may be implemented using one device that is physically or logically coupled, or may be implemented using two or more devices that are physically or logically separated and are connected directly or indirectly (e.g. using wires, wireless, etc.). Functional blocks may be implemented in combination with software in one or more of the above-described devices.

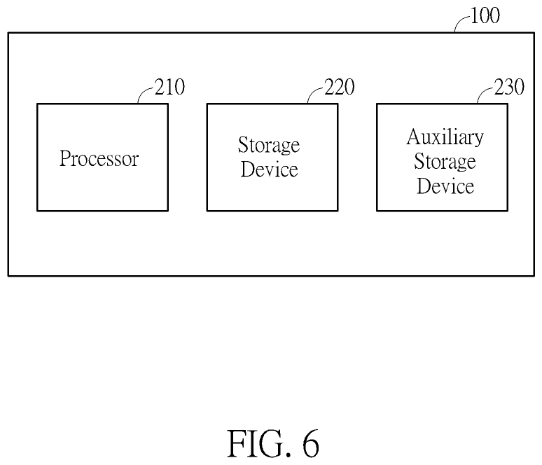

According to one embodiment, the wireless communication device 100 may function as a computer that performs processing. FIG. 6 is a schematic diagram illustrating an example of a hardware configuration of the wireless communication device 100 according to one embodiment of the present invention. The wireless communication device 100 described above may be physically configured as a computer device including a processor 210, a storage device 220 and an auxiliary storage device 230. Each function in the wireless communication device 100 may be achieved by having the processor 210 read a predetermined software (program) on hardware such as the storage device 220, to perform the operation, to control wireless communication with a base station. The processor 210, for example, operates an operating system to control the entire computer. The processor 210 may include a central processing unit (CPU) including interfaces with peripheral devices, control devices, computing devices, registers, and the like. Moreover, the processor 210 reads programs (program codes), software modules, data, and the like from the auxiliary storage device 230 to the storage device 220, and performs various processing in accordance therewith.

In one embodiment, the scenario determination unit 111, a software power estimator 112, the control unit 115 and/or the calibration unit 116 of the wireless communication device 100 may be implemented by a control program that is stored in the storage device 220 or the auxiliary storage device 230 and operates in the processor 210. While the various operations and processes described above have been described as being executed by one processor 210, they may be executed simultaneously or sequentially by two or more processors 210. Processor 210 may be implemented by one or more chips. In one embodiment, the storage device 220 is a computer readable storage medium and may be configured of at least one of, for example, a ROM (Read Only Memory), an EPROM (Erasable Programmable ROM), an EEPROM (Electrically Erasable Programmable ROM), or a RAM (Random Access Memory). In one embodiment, the storage device 220 may be referred to as a register, a cache, a main memory (main storage device), or the like. The storage device 220 can store programs (program codes), software modules, and the like that are executable to perform the processing according to one embodiment of the present invention. In one embodiment, the auxiliary storage device 230 is a computer readable storage medium and may be configured of, for example, a smart card; a flash memory (e.g. a card, a stick, or a key drive). Moreover, the wireless communication device 100 may be configured including hardware such as a microprocessor, a digital signal processor (DSP), an ASIC (Application Specific Integrated Circuit), a PLD (Programmable Logic Device), or a FPGA (Field Programmable Gate Array). The hardware may also implement some or all of each functional block.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for perform power control on a wireless communication device, comprising:
a power estimator, configured to generate an estimated power value by querying power mapping information according to scenario information;
a power meter, configured to generate a measured power value based on measurement of power supplied to partial circuits of the wireless communication device;
a calibration unit, coupled to the power estimator and the power meter, configured to generate a calibrated power value according to the estimated power value and the measured power value, and accordingly to update the power mapping information based on the calibrated power value and the scenario information; and
a control unit, coupled to the power estimator, configured to perform power control on the partial circuits of the wireless communication device according to the estimated power value.

2. The apparatus of claim 1, further comprising:
a scenario determination unit, coupled to the power estimator, configured to determine the scenario information according to operational-related data collected within the wireless communication device.

3. The apparatus of claim 2, wherein the scenario determination unit is configured to determine the scenario information according to the operational-related data collected during a transmission time interval (TTI).

4. The apparatus of claim 3, wherein the power meter is configured to generate the measured power value according to one or more samples of measurement of power supplied to the partial circuits of the wireless communication device during the TTI.

5. The apparatus of claim 1, further comprising:
a storage unit, coupled to the power estimator, configured to store a look-up table recording the power mapping information, wherein each entry of the look-up table includes a specific scenario of possible scenarios of the partial circuits of the wireless communication device and a corresponding reference power value;
wherein the power estimator is configured to query the look-up table based on a current scenario indicated by the scenario information to obtain a current reference power value and accordingly generate the estimated power value according to the current reference power value; and the calibration unit is configured to modify one or more entries of the look-up table according to the calibrated power value to update the power mapping information.

6. A method of performing power control on a wireless communication device, comprising:
generating an estimated power value by querying power mapping information according to scenario information;
generating a measured power value based on measurement of power supplied to partial circuits of the wireless communication device;
generating a calibrated power value according to the estimated power value and the measured power value, and accordingly updating the power mapping information based on the calibrated power value and the scenario information; and
performing power control on the partial circuits of the wireless communication device according to the estimated power value.

7. The method of claim 6, further comprising:
determining the scenario information according to operational-related data collected within the wireless communication device.

8. The method of claim 7, wherein the step of determining the scenario information comprises:
determining the scenario information according to the operational-related data collected during a transmission time interval (TTI).

9. The method of claim 8, wherein the step of generating the measured power value comprising:
generating the measured power value according to one or more samples of measurement of power supplied to the partial circuits of the wireless communication device during the TTI.

10. The method of claim 6, further comprising:
providing a storage unit store a look-up table recording the power mapping information, wherein each entry of the look-up table includes a specific scenario of possible scenarios of the partial circuits of the wireless communication device and a corresponding reference power value;
querying the look-up table based on a current scenario indicated by the scenario information to obtain a current reference power value and accordingly generating the estimated power value according to the current reference power value; and
modifying one or more entries of the look-up table according to the calibrated power value to update the power mapping information.

11. A wireless communication device, comprising:
a power meter, configured to generate a measured power value based on measurement of power supplied to partial circuits of the wireless communication device;
a power control module, configured to perform power control on the wireless communication device, comprising:
a power estimator, configured to generate an estimated power value by querying power mapping information according to scenario information;
a calibration unit, coupled to the power estimator and the power meter, configured to generate a calibrated power value according to the estimated power value and the measured power value, and accordingly to update the power mapping information based on the calibrated power value and the scenario information; and
a control unit, coupled to the power estimator, configured to perform power control on the partial circuits of the wireless communication device according to the estimated power value.

12. The wireless communication device of claim 11, wherein the power control module further comprises:
a scenario determination unit, coupled to the power estimator, configured to determine the scenario information according to operational-related data collected within the wireless communication device.

13. The wireless communication device of claim 12, wherein the scenario determination unit is configured to determine the scenario information according to the operational-related data collected during a transmission time interval (TTI).

14. The wireless communication device of claim 13, wherein the power meter is configured to generate the measured power value according to one or more samples of measurement of power supplied to the partial circuits of the wireless communication device during the TTI.

15. The wireless communication device of claim 11, wherein the power control module further comprises:
a storage unit, coupled to the power estimator, configured to store a look-up table recording the power mapping information, wherein each entry of the look-up table includes a specific scenario of possible scenarios of the partial circuits of the wireless communication device and a corresponding reference power value;
wherein the power estimator is configured to query the look-up table based on a current scenario indicated by the scenario information to obtain a current reference power value and accordingly generate the estimated power value according to the current reference power value; and the calibration unit is configured to modify one or more entries of the look-up table according to the calibrated power value to update the power mapping information.
